(19) United States
(12) Patent Application Publication
(10) Pub. No.: US 2009/0027161 A1
(43) Pub. Date: Jan. 29, 2009

(54) Access Control System and Method for Controlling Access to a Monitored Element

(75) Inventor: John Bradley Kent, Olney (GB)

Correspondence Address: RANKIN, HILL & CLARK LLP, 925 EUCLID AVENUE, SUITE 700, CLEVELAND, OH, 44115-1405, US

(73) Assignee: TRAKA LIMITED, Olney (GB)

(21) Appl. No.: 12/147,690

(22) Filed: Jun. 27, 2008

(30) Foreign Application Priority Data
Jun. 28, 2007 (GB) 0712664.2

(51) Int. Cl. G05B 19/00

(52) U.S. Cl. 340/5.73

(57) ABSTRACT

The present invention provides an access control system for controlling access to equipment, the system comprises a storage location for storing a plurality of electronic access devices, each being associated with a particular piece of equipment. A control means is arranged to identify the user and to allow a selection from one or more access devices based on the user's identity. If the device selected requires a test for the physical state of the user, then the control means is configured to allow the device to be withdrawn only if the user satisfies certain predetermined conditions.

### FIELD OF THE INVENTION

The present invention relates to an access control system and method for controlling access to a monitored element. In particular, the invention is directed to the prevention of access to a monitored element such as a key to equipment, unless a user is properly authenticated and satisfies certain preconditions for using the concerned equipment. The types of equipment in question for the purposes of the present invention are mostly motor vehicles and the preconditions that a user or driver of such equipment require to meet relates to his/her physical state. The monitored element may be other types of equipment of even areas of a building.

### BACKGROUND OF THE INVENTION

A system of monitoring access to elements such as keys has already been proposed by the present applicant. In such a system, the usage of equipment such as motor vehicles is monitored by attaching the ignition or door key of the vehicle to a special intelligent key fob. The key may be attached to the special key fob using a standard key ring or where added security is required, security seals. The special key fob is monitored and the key fobs to which the keys are attached are stored in a special cabinet and a key can only be removed from the cabinet by an individual identifying himself to computer equipment associated with the cabinet. The identification may be through the use of a ID card being inserted into a card reader provided on the cabinet or entering an ID number on a key pad situated on the cabinet.

Another proposed system for monitoring keys for operating equipment utilizes keys that are identical mechanically but differentiated electrically from one another. In this system, the key fobs in the previous system do not have a mechanical key for the equipment. This proposal is described in International Patent Publication WO01/75811 in the name of the present applicant.

Such systems are useful in monitoring usage of keys for equipment in general.

When it comes to the monitoring of access to keys of equipment that need special user attention such as motor vehicles, especially commercial ones such as trucks or cabs etc., there is a requirement to prevent vehicle keys from being accessed by a user, even if the user in question is properly authenticated, if the user is in a state that renders him/her physically unsuitable to drive or to operate the equipment. Particularly there is a need to prevent access to the key of motor vehicle if a user has consumed alcohol or any other drugs that may impair his/her driving.

The present invention addresses this requirement and provides a system for monitoring access to equipment taking the physical condition of the user into consideration.

### SUMMARY OF THE INVENTION

Accordingly the present invention provides an access control system for controlling access to equipment or locations, the system comprising a storage location for storing a plurality of access devices, each of said access devices being associated with a particular piece of equipment, the access of a user to said access devices being monitored by a control means provided for said storage location, said control means being arranged to identify the user and to allow a selection from one or more access devices based on the user's identity, wherein on selection of a particular access device said control means is configured to allow the user to access the selected access device from the storage location based on a result of a test done by a physical-state determining means on the user, if said result is required by the control means to allow access to the selected access device.

### BRIEF DESCRIPTION OF THE DRAWINGS

FIG. 1 shows an example of a storage location comprising a key cabinet.

FIG. 2a shows an example an electronic key fob

FIG. 2b shows an example of the key fob with its associated mechanical key which has been extracted from the storage location.

FIG. 3 shows an example of a physical state determining means that could be implemented at the storage location.

FIG. 4 is a flowchart detailing the operation steps of the present invention

### DETAILED DESCRIPTION OF THE INVENTION

The preferred embodiment will be described with reference to the accompanying drawings and the description will be directed to the access of keys of a motor vehicle. It is to be appreciated that the invention is not restricted only to access control to vehicles and includes access to all equipment requiring a special attention of the operator and also access control to locations that may be restricted to certain users.

Also, it is to be appreciated if there is a possibility that a large number of pieces of identical equipments are used or alternatively a few pieces of equipment are required by a large number of users then in either case it is wished to control and monitor the keys which activate these equipment which may be physically similar using a coded key fob which can be used as a activation key to operate the vehicle as well, as described in our prior publication WO01/75811.

The following description will be based on the assumption that mechanical keys that are used for motor vehicle ignition are attached to the electronic key fobs.

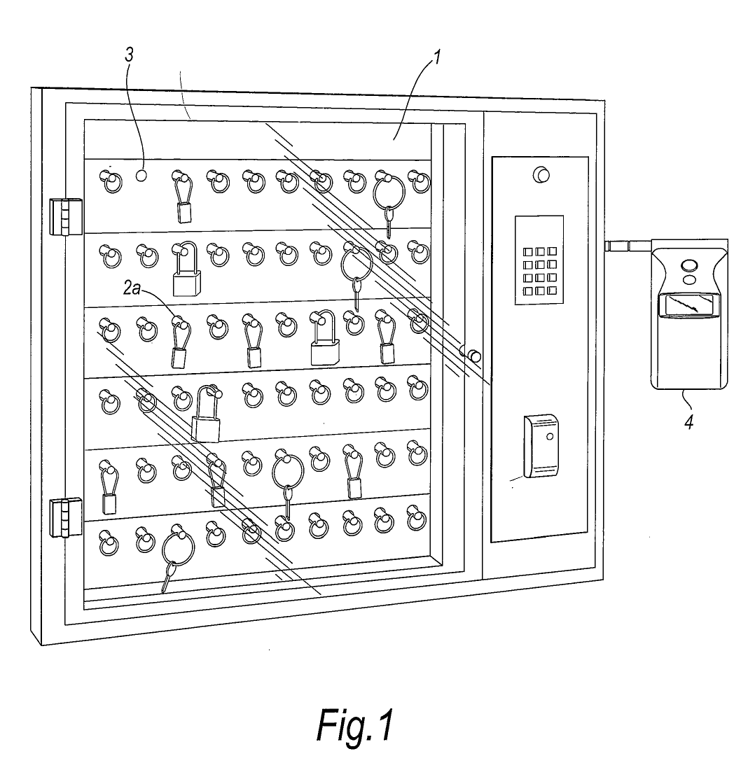

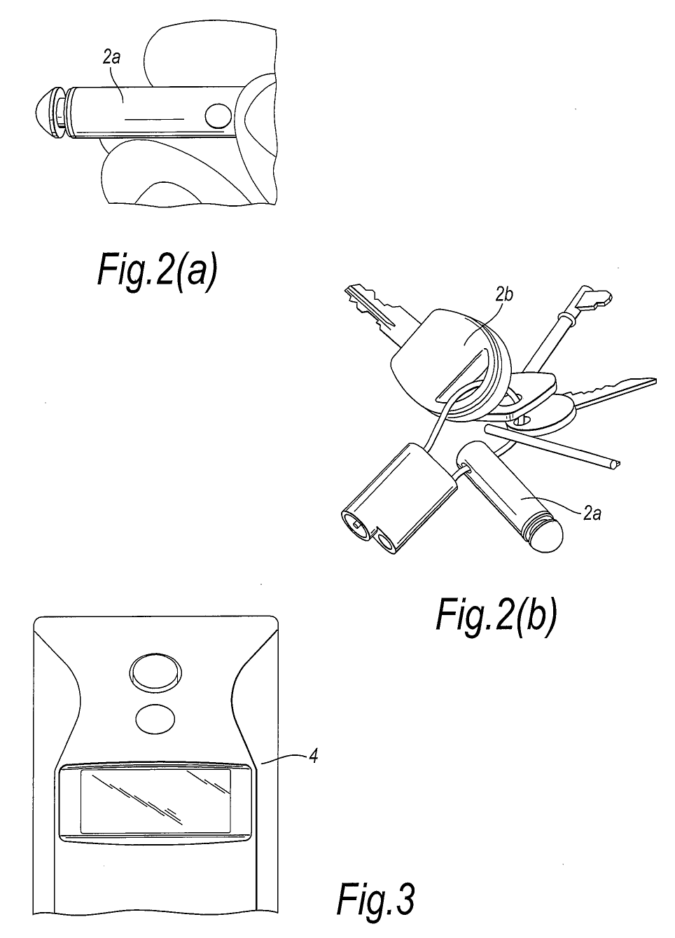

FIG. 1 shows the implementation of the present invention at the point of accessing the keys of the equipment. The main components of the system are the key storage location (1), a plurality of activation devices, which are electronic key fobs (2a) having vehicle keys (2b) attached to them. Examples of these key fobs and vehicle keys are seen in FIGS. 2a and 2b respectively. These activation devices are arranged to be stored in key slots (3) at the storage location (1). The system also includes a physical state-determining means (4), an example of which is seen in FIG. 3. Such determining means (4) is provided to allow access to the keys (2a, 2b) only if certain conditions are met by a user. This physical-state determining means (4) may be located within the storage location (1) or anywhere in the vicinity the storage location (1) such that it may be easily accessed by a user requiring a key.

The storage location (1), which is in the form of a key cabinet, contains a number of key slots (3) for retaining the key fobs (2a). These fobs (2a) attached to the mechanical keys (2b) are physically retained in the key slots (3) but can be individually released under microprocessor control when a user correctly identifies himself to a microprocessor (not shown in figures) which is in connection with the storage location (1) and controls the overall working of the system. Accessing the microprocessor can be done by utilising a keypad or card reader or other means of identification associated with the storage location (1). Identification by using a card reader or biometric means may be considered more useful than key pads requiring PIN numbers in that the card could contain all the data required to identify the user. Whereas with a key pad identification method, the identification number would need to be compared to possible numbers stored in a central database, thereby requiring connection to a central database, in order to obtain data in relation to a particular user.

The retention of keys is not essential in view of the fact that the cabinet may be fitted with a door (not shown in figures), which can be opened only after a user has correctly identified himself. This identification can be in any convenient form e.g. one or more of a PIN access, a swipe of a card biometric access-using fingerprint etc. In this case, the key that will be removed will automatically become associated with the user who gives his identity to the system.

The microprocessor is arranged to store information relating to the type of equipment, and the operating requirements and conditions under which the equipment can be operated. User information is also present in a central database. In the preferred embodiment of present invention, the information that is likely to be accessed by the system is be the type of vehicles that a particular user is licensed to drive. Other information such as time of day or duration of allowed usage etc. can be programmed as well.

In a preferred embodiment, the key fobs (2a) all look identical to each other but each are electronically different with a different vehicle key (2b) associated with it. The key fobs (2a) have electronic memory means such that these fobs (2a) as well as the vehicle key (2b) associated with it can be rendered as having a unique identification together. The microprocessor connected to the central database can monitor and log which user is allowed to use which types of vehicles and the user in question could be directed to access only those specific keys (2a,2b) for which has he has a license for. Access to these certain allowed keys (2a,2b) is activated or confirmed only is a user passes a test put forth by the physical state determining mean (4). This is usually a breath test to determine the breath alcohol content of a user.

Such indication of the keys allowed for a user could be provided by way of any convenient indication such as an LED light associated with each slot (3) being illuminated etc. Another way of allowing access to a particular fob (2a) is to first have the user enter the key fob (2a) identification number (seen in FIG. 2b) unique to each key fob at a key pad, or push a button that may be present beside each fob. Then the microprocessor accesses the central database to check if that particular user is allowed access to that particular key fob (2a) which is associated to a particular vehicle key (2b).

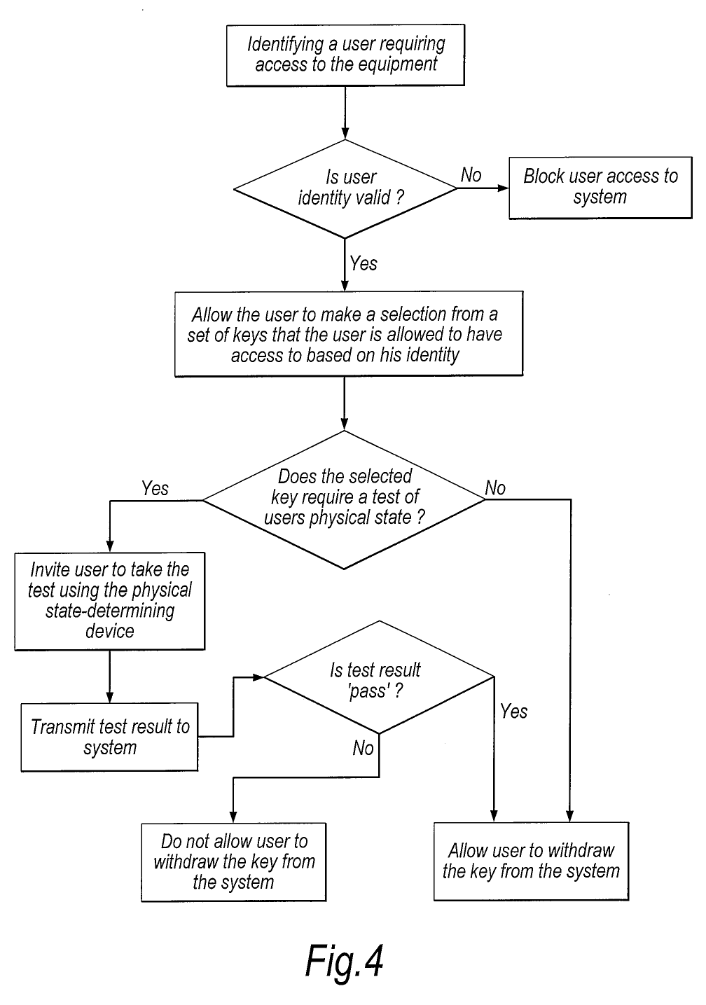

The operation of the above-mentioned components of the system according to the present invention is described as follows and is shown in the flowchart depicted in FIG. 4.

A user presents his identity at the storage location. This identification can be done as mentioned above by using either a keypad for entering a PIN, an ID card which could be swiped by a card reader or any other type of identification means. Once the user has been authenticated by the microprocessor as a valid user he/she is then allowed to indicate by any of the indication methods previously mentioned which key fob (2a) is required for use. As mentioned before, it is also possible for the system to point out to the user the key fobs (2a) that he/she will be able to access and the user can make a selection only from theses allowed key fobs (2a) by any known means such as entering the fob ID or pushing a button next to the fob.

If the user does submit a valid identity to the system, the user will not be allowed to proceed any further and access to all keys in the storage location (1) are blocked.

The storage location (1) as previously mentioned could be a cabinet provided with a door. If this is the case, then on proper user identification the door can be opened by the user so that he/she can proceed to indicate the required the key fobs (2a). If not, the door of the cabinet remains shut.

Once the user indicates which key fob (2a) having the vehicle key (2b) that is required for use, the microprocessor system will indicate to the user whether the user's physical state needs to be checked before allowing the user access to the particular vehicle key (2b) which is associated with the fob (2a). Such date is stored in the electronic memory of the fob (2a) and can be linked to the central database.

This indication can be done by the system providing any type of visual indication on a display means requesting the user to take the test provided by the physical state determining means (4), or else the system will just not release the key which will indicate to the user that the test is required to be taken before withdrawing the key (2a,2b) from the location (1)

It is to be appreciated that not all types of keys may require a test by a physical state determining means (4) as some of the keys (2b) may operate other types of equipment that do not need a physical state test. Therefore it is preferable to have the physical state determining means (4) test for testing a users ability to use the vehicle after the properly identified user selects a key fob (2a) that requires a pass result from such a test.

The alternative will be the possibility of having the test done by the determining means (4) at the time of initial identification itself such that access to all keys within the cabinet is allowed only if pass result is achieved. This may be desirable if all key fobs (2a) in the cabinet carry keys (2b) that operate motor vehicle or other types of equipment that require diligence on the part of the user.

The physical state determining means (4) according to the present invention is preferably in the form of a breath analyser, wherein the user's breath can be tested for alcohol concentration. If the user has consumed alcohol and the amount of alcohol concentration is above a predetermined allowable limit, then a fail result will be generated by the determining means (4). The breath analyser can also be programmed to generated a ‘fail’ result if any other form of other drugs (including prescribed drugs that will be detected by the analyser) or strong dosage of medication is detected, as even in these cases a driver will be in an unfit state to drive a vehicle. The failed test result is configured be transmitted to the microprocessor which in turn does not activate the electronic key fob (2a) for release from the storage location (1). Therefore the key fob with the vehicle keys (2b) in question remains locked within the cabinet and will not be released for use by that user.

If the user had not consumed alcohol or any other drug dosage or the amount of alcohol is determined as below the predetermined limit, a ‘pass’ result will be generated and sent to the microprocessor. This pass result will trigger the microprocessor to activate the key fob (2a) for release. The user will then be able to remove this key fob (2a) from the cabinet and the mechanical key (2b) associated with the fob can be used to operate the vehicle.

In the preferred embodiment, the microprocessor allows a validated user to remove only one key fob (2b) from the cabinet at a time. This may be is to ensure that a user does not take more than one vehicle key using his identification and to pass on the second key or other keys to another user who may not be fit to drive. However, since a particular user will be associated with a particular vehicle, they changes of such misconduct are likely not to exist

The responsibility of returning the key (2a, 2b) to the cabinet lies with the user. As mentioned previously and is known from the prior art, each key set that is removed from the storage location (1) is associated with the particular user who withdrew it and therefore the users are held accountable for keys that may be missing for a certain period of time.

It is preferred to have a security system that operates alongside the present invention, the main purpose of such a system being the possibility of ensuring that the user who submits his/her ID to withdraw the keys form the storage location (1) is the same person who takes the test required by the physical state determining means (4). This is to prevent a colleague who has not consumed alcohol or medication to take the breath test instead of the user who actually intends to drive the vehicle. CCTV systems could implement such security measures so that the misconduct of the part of the parties involved can be detected and dealt with.

Security systems, like biometric detection systems, Iris scan systems etc., could be well suited to achieve the security that the present invention requires. It may be preferred to have a security device that performs an iris scan simultaneously with the breath test. It will be further preferred if the same device that performs the breath test also has functionality to perform the iris scan to identify the person using the breath analyser. This way the system can ensure that the person giving the breath sample and the person accessing the keys are the same individual. The system can be configured to deny access if the identities don't match.

1. An access control system for controlling access to equipment, the system comprising a storage location for storing a plurality of access devices, each of said access devices being associated with a particular piece of equipment, the access of a user to said access devices being monitored by a control means provided for said storage location, said control means being arranged to identify the user and to allow a selection from one or more access devices based on the user's identity, wherein on selection of a particular access device said control means is configured to allow the user to access the selected access device from the storage location based on a result of a test done by a physical-state determining means on the user, if said result is required by the control means to allow access to the selected access device.

2. The access control system as claimed in claim 1 wherein said physical-state determining means is a breath analyser.

3. The access control system as claimed in claim 1 or 2 wherein said physical-state determining means is provided for determining alcohol concentration in the users breath.

4. The access control system as claimed in any one of claims 1 to 3 wherein said result of the test is ‘pass’ if no alcohol concentration is present or if the alcohol content in the user's breath is below a predetermined level and is ‘fail’ otherwise.

5. The access control system as claimed in any one of claims 1 to 4 wherein said if said result is ‘pass’, said control means is configured to activate the access device thereby allowing the user to access said access device and if said result is ‘fail’ the control means does not activate the access device thereby blocking the users access to said access device.

6. The access control system as claimed in any one of claims 1 to 5 wherein said access devices are arranged in slots provided in the storage location, said slots being controlled by the control system to activate or the access devices when said result is a ‘pass’.

7. The access control system as claimed in claim 1 wherein if a result of the physical-state determining means is not required for the selected access device, then the control means is configured to directly allow access to said device.

8. The access control system according to any one of the preceding claims wherein said access device comprises a mechanical key.

9. The access control system according to any one of the preceding claims, wherein the access control device comprises a fob.

10. The access control device according to claim 9, wherein the fob includes electronic circuitry for identifying the fob.

11. The access control system as claimed in claim 1 wherein said equipment is a motor vehicle.

12. The access control system as claimed in claims 8, 9 or 10 wherein said mechanical key is a key for operating a vehicle.

13. The access control system as claimed in claim 1 wherein the control means is a microprocessor.

14. The access control system as claimed in any one of the preceding claims wherein the user's identity is authenticated against details stored in a database, which can be accessed by the microprocessor.

15. The access control system as claimed in any one of the preceding claims wherein a user is allowed to withdraw one access device at a time from the storage location.

16. The access control system as claimed in any one of the preceding claims wherein the storage location is a cabinet.

17. The access control system as claimed in any one of the preceding claims wherein a security device is provided to ensure that the user taking the test from the physical-state determining means is the same user initially identified by the control means.

18. A method for controlling access to a monitored element using the access control system claims in any preceding claim comprises the steps of:
Identifying a user by the system;
allowing the properly identified user to make a selection from one or more access devices depending on the user's identity;
if the selected access device requires a test result from a physical-state determining means then indicating to the user to take the test, transmitting the test result to a control means and if said test result is a pass, allowing the user to withdraw the access device from the system;
if the selected device does not require a test result from the physical-state determining means, allowing the user to withdraw the access device from the system.
